(19) United States
(12) Patent Application Publication
(10) Pub. No.: US 2026/0134298 A1
(43) Pub. Date: May 14, 2026

(54) METHOD FOR GENERATING AND MANAGING AN AI COMPANION, AND SYSTEM USING THE SAME

(71) Applicant: PLAIN BAGEL INC., Seoul (KR)

(72) Inventors: Jin Jae YOO, Seoul (KR); Jeehoon KANG, Yongin-si (KR)

(21) Appl. No.: 18/963,694

(22) Filed: Nov. 28, 2024

(30) Foreign Application Priority Data
Nov. 12, 2024 (KR) 10-2024-0159903
Nov. 12, 2024 (KR) 10-2024-0159907
Nov. 12, 2024 (KR) 10-2024-0159908

(51) Int. Cl. G06N 5/022

(52) U.S. Cl. CPC G06N 5/022

(57) ABSTRACT

An AI companion creation and management system according to an embodiment of the present invention relates to an integrated system for the creation, sharing, and utilization of AI companions. The system generates an AI companion through the text embedding generation unit and the knowledge graph generation unit, allows other users to utilize it via the sharing unit, and supports actions and development within content through the response generation unit and the state analysis unit. Additionally, all information is managed integrally through the storage unit, and the system operates based on LLM (Large Language Model) or SLM (Small Language Model). The present invention provides a scalable platform in which all functions related to the AI companion are organically connected and operate, which can serve as the core infrastructure for future AI companion services

### CROSS-REFERENCE TO RELATED APPLICATIONS

This patent application claims priority to Korean Patent Application No. 10-2024-0159903, filed Nov. 12, 2024 and the entire contents of which are incorporated herein by reference, Korean Patent Application No. 10-2024-0159907, filed Nov. 12, 2024 and the entire contents of which are incorporated herein by reference, and Korean Patent Application No. 10-2024-0159908, filed Nov. 12, 2024 and the entire contents of which are incorporated herein by reference.

### TECHNICAL AREAS

The present invention relates to AI companion creation and management technology, and more specifically, to a system and method for creating AI companions with unique personas using users'natural language data and enabling other users to utilize these companions in their own content.

### THE TECHNOLOGY BEHIND THE INVENTION

Recent developments in artificial intelligence have increased interest in AI companions capable of engaging in natural conversations with users. Particularly in diverse contents such as games, novels, and metaverses, the use of AI characters is expanding, highlighting the need for technologies that enable users to create, share, and employ their own AI characters. However, current AI companion technologies are often restricted to producing predefined responses or fail to adequately capture the context of the content. Furthermore, there is a deficiency in the systems designed to effectively store and utilize the knowledge and memories of AI companions, complicating the possibility of natural and sustained interactions.

### SUMMARY

### The Present Invention Aims to Resolve the Following technical challenges:

First, it seeks to provide a method and system that can integrally manage the entire process from the creation to the sharing, utilization, and updating of AI companions.

Second, it aims to offer a scalable platform that allows numerous users to create, share, and use their own AI companions across various types of content.

Third, it intends to provide an integrated system structure capable of effectively storing, retrieving, and updating the knowledge and memories of AI companions.

The objectives of this invention are not confined to the issues discussed above; additional objectives not mentioned here will become evident to those skilled in the art from the description below.

To address the challenges described above, an AI companion generation and management system according to one embodiment of the present invention first generates an AI companion from natural language data of a user through a text embedding generator and a knowledge graph generator. The text embedding is responsible for vectorizing sentence units, and the knowledge graph is responsible for storing information in a triplet structure.

Second, it enables other users to copy and utilize AI companions created through the sharing unit, and enables the copied AI companions to behave and evolve within the content through the response generation and state analyzers.

Third, the repository unifies and manages the information of all AI companions and their activities in content, and enables the entire system to operate based on a large language model (LLM) or small language model (SLM).

Specific details of other embodiments are included in the detailed description and accompanying drawings.

Therefore, according to the present invention, there are various benefits as described below:
First, all functionalities related to AI companions are provided in one unified system, enabling users to create and utilize AI companions more easily and efficiently.

Second, the dual structure of knowledge graphs and text embedding enables the systematic storage and utilization of the AI companion's information, facilitating more natural and intelligent interactions.

Third, the scalable platform structure allows for the development of an ecosystem where numerous users, AI companions, and diverse content can be organically interconnected and grow.

Fourth, compatibility with various immersive platforms such as virtual reality, augmented reality, and metaverses allows for the provision of forward-looking AI companion services.

The benefits of this invention are not limited to the examples given above; many more are detailed within this specification.

### BRIEF DESCRIPTION OF THE DRAWINGS

FIG. 1 is a comprehensive block diagram of an AI companion creation and management system, according to one embodiment of the present invention.

FIG. 2 is a drawing to illustrate a method for creating and sharing an AI companion according to one embodiment of the present invention.

FIG. 3 is a drawing to illustrate a knowledge graph structure of an AI companion according to one embodiment of the present invention.

FIG. 4 is a drawing to illustrate a method for sharing and managing AI companions according to one embodiment of the present invention.

### DETAILED DESCRIPTION OF THE EMBODIMENTS

Various embodiments of the present invention are described in detail with reference to the accompanying drawings. The advantages and features of the invention, along with methods for achieving them, are clearly understood through the detailed descriptions of the embodiments referenced alongside the drawings. However, the scope of the invention is not confined to the disclosed embodiments but is capable of being embodied in various forms. These embodiments are provided merely to ensure a thorough disclosure, helping those of ordinary skill in the related art grasp the full scope of the invention, which is defined by the claims.

The shapes, sizes, proportions, angles, and numbers illustrated in the drawings to describe embodiments of the invention are exemplary and do not limit the invention to the specifics shown. Identical reference numbers across the specification denote identical components. Furthermore, in describing the invention, detailed descriptions of known related technologies are omitted if they are deemed to obscure the essence of the invention unnecessarily. Terms such as ‘comprises,’ ‘has,’ ‘consists of,’ and similar are used herein to mean that other elements or steps may be included unless the term ‘only’ is explicitly used. If a component is described in the singular, it is to be understood as including the plural unless otherwise specified.

Components are interpreted to include tolerances, even if not explicitly stated.

Descriptions of positional relationships, such as ‘on top of,’ ‘above,’ ‘below,’ ‘next to,’ etc., imply that one or more additional units may exist between the specified units unless the terms ‘directly’or ‘immediately’are used.

When an element or layer is said to be ‘on’ another, it includes configurations where other elements or layers are interposed directly on top of, or between, them.

Although terms such as ‘first,’ ‘second,’ etc., are used to describe various components, these components are not limited by these terms. These terms are used merely to distinguish one component from another within the context of the invention. Thus, a component referred to as ‘first’ could technically be a ‘second’component within the scope of the invention.

Throughout this specification, identical reference numbers refer to the same components.

The sizes and thicknesses of components shown in the drawings are for illustrative purposes only and do not confine the invention to the depicted dimensions.

The features of the various embodiments of the invention can be combined or arranged in interaction either partially or wholly, as understood by those skilled in the art, allowing for various technical interconnections and operations. Each embodiment can be implemented independently or in combination with others.

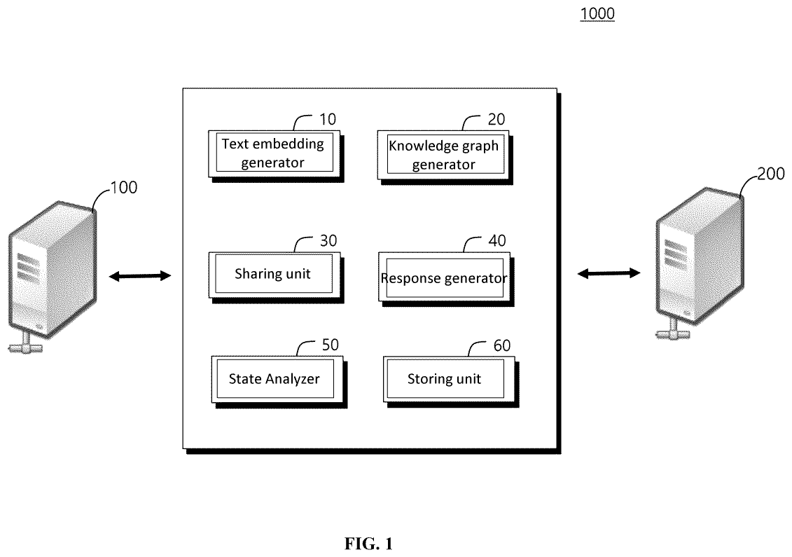

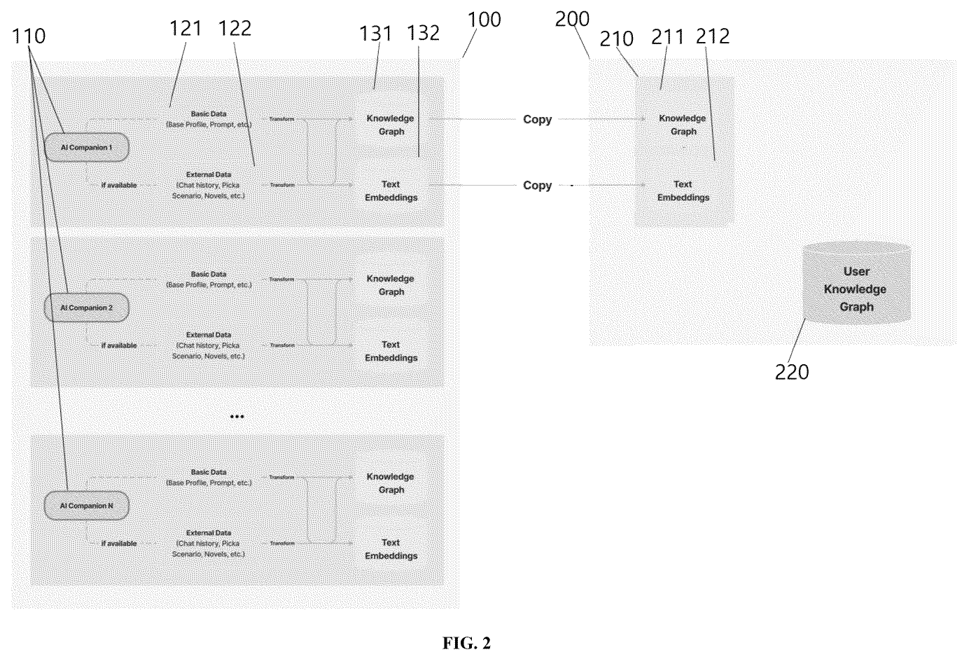

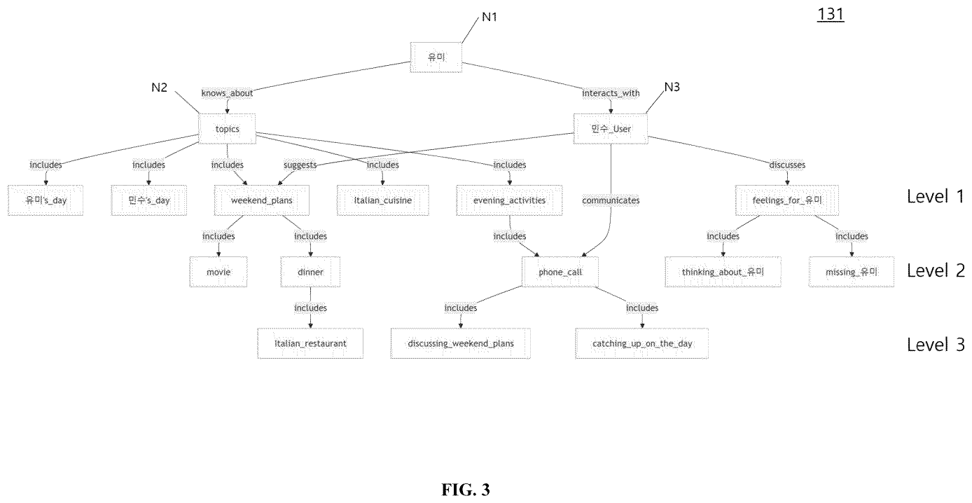

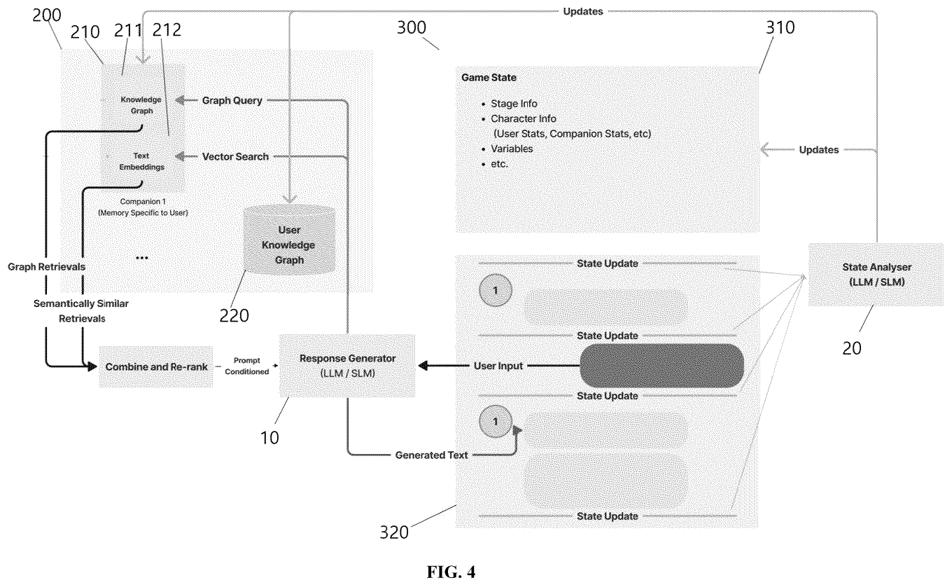

FIG. 1 is a comprehensive block diagram of an AI companion creation and management system, according to one embodiment of the present invention. FIG. 2 is a drawing to illustrate a method for creating and sharing an AI companion according to one embodiment of the present invention. FIG. 3 is a drawing to illustrate a knowledge graph structure of an AI companion according to one embodiment of the present invention. FIG. 4 is a drawing to illustrate a method for sharing and managing AI companions according to one embodiment of the present invention.

Referring to FIGS. 1 to 4, the AI companion creation and management system 1000 of the present invention is a system for generating an AI companion 110 using the natural language data of a user and enabling other users to utilize it in their content. It is an integrated system comprising a text embedding generator 10, a knowledge graph generator 20, a sharing unit 30, a response generator 40, a state analyzer 50, and a storage unit 60. The AI companion creation and management system 1000 facilitates communication with the first user 100, who is the originator of the AI companion 110, and the second user 200, who uses the created AI companion 110 in their content. The term ‘first user 100’ may refer to the device of the first user, and ‘second user 200’ may refer to the device of the second user.

The components of system 1000 are organically connected and operate as follows: The text embedding generator 10 produces text embedding 132 by vectorizing sentences chunked from basic data 121 and additional data 122. The knowledge graph generator 20 creates a knowledge graph 131, a collection of triples starting with the subject node N1. Sharing unit 30 facilitates the sharing process where the created AI companion 110 is copied and utilized by other users, enabling the second user 200 to use the copied AI companion 210 in his or her contents. The state analyzer 50 analyzes interactions within the content to update content state information 310, and this update is reflected in knowledge graph 211 and text embedding 212 of the copied AI companion 210. The response generator 40 combines and re-ranks the results from the knowledge graph and vector searches within text embedding 132 to generate contextually appropriate responses, while the storage unit 60 manages and stores all data. Particularly, the second user's knowledge graph 220 provides a personalized experience, and the entire system operates based on Large Language Models (LLM) or Smaller Language Models (SLM).

Specifically, the text embedding generator 10 is a key component in generating the vector-based knowledge structure underlying the AI companion 110. The text embedding generator 10 generates text embedding 132 by chunking the persona data of the first user 100 and converting it into coordinate values in a multidimensional vector space so that each has a unique location in the vector space. As a first step in processing the basic data 121 and additional data 122 input from the first user 100, the entire data is chunked into appropriately sized sentence units that consider the input limitations of the LLM model. During the chunking process, the unit size can be adjusted either on a per-line basis or on a dialogue chunk (paragraph) basis while maintaining contextual continuity, which is to prevent data loss that can occur as the amount of prompts increases. The chunked conversations are converted into specific coordinate values (address values) in vector space through an embedding model, where contextual similarity is expressed as a distance in vector space, that is, contextually similar data is given coordinate values in vector space so that they are located in close proximity. The resulting text embedding 132 is particularly effective for quickly locating similar contextual information and is stored in a form that is easy to retrieve and utilize.

The knowledge graph generator 20 plays a pivotal role in storing the knowledge and experience of the AI companion 110 in a structured form. Referring to FIG. 3, the knowledge graph 131 has a structure that starts with a top-level subject node N1 and branches into information node N2 and relationship node N3. Below the information node N2 and the relationship node N3, a hierarchical structure is formed, starting from the first level (LEVEL 1) and going down to the third level (LEVEL 3). The number of levels is not limited and can be increased or decreased as needed. The information node N2 stores all knowledge information held by the AI companion 110, and the relationship node N3 stores relationship information between the AI companion 110 and the content user.

In particular, some nodes under the information node N2 and the relationship node N3 are present by default, while others are added dynamically during the triplet generation process. The relationship between each node is represented by a directional arrow, which allows information to be connected and extended through the subject-relationship-object triplet structure. This structure enables effective storage and utilization of contextual information, such as the emotions and intentions of the AI companion 110, and in particular, enables the representation of complex relationships and contexts. Specifically, the knowledge graph may be an aggregation of multiple triplets, where nodes represented by squares may indicate subject entities or object entities, and arrows may represent relationship entities connecting subject entities and object entities. Two adjacent and connected triplets share a node, where the shared node can be the object entity of the preceding triplet and the subject entity of the subsequent triplet.

The sharing unit 30 is a key intermediary component that enables other users to utilize the original AI companion 110 created by the first user 100. The knowledge graph 131 and text embedding 132 of the original AI companion 110 are copied by the second user 200 to create a new copied AI companion 210, which has an independent knowledge graph 211 and text embedding 212. The copied AI companion 210 retains the persona of the original, but its subsequent evolution can be independent of the context of its respective content. In particular, personalized interaction history is maintained separately through the second user knowledge graph 220, which allows copied AI companions 210 to evolve in different ways based on their relationship with the second user 200, even though they are copied from the same original AI companion 110.

Sharing unit 30 also includes security mechanisms to enable effective sharing while protecting the copyright and privacy of the original AI companion 110. Through this sharing system, a foundation is established for one original AI companion 110 to be utilized and evolved across various content according to their respective characteristics. The basic data 121 and additional data 122 of the original AI companion 110 can be utilized as data to prove that the first user 100 is the original creator of the original AI companion 110, and even when the original AI companion 110 is copied by the second user 200 to create a copied AI companion 210, the basic data 121 and additional data 122 can be managed under the control of the storage unit 60 without being copied as belonging to the second user 200.

The state analyzer 50 is a critical management component that analyzes all interactions occurring in the content (games, etc.) in real time and updates the copied AI companion 210. The state analyzer 50 continuously updates the content state information 310 whenever there is input from a particular user using the content and whenever there is a response from the copied AI companion 210, during which all contextual information of the content, such as stage information, character information (User States, Companion States), and various variables, is updated. The updated information is reflected in the knowledge graph 211 and text embedding 212 of the copied AI companion 210 in real time, allowing the copied AI companion 210 to react appropriately to the current situation. The state analyzer 50 operates based on LLM or SLM to effectively analyze and process even complex interaction patterns, and is specifically designed to allow dynamic updates while maintaining continuity and consistency of state changes. This allows the copied AI companion 210 to naturally adapt and evolve as the content progresses.

The response generator 40 is the core engine component that generates the responses of the copied AI companion 210 to user input. When input comes in, it first performs a Graph Query on the knowledge graph 211 to gather relevant triplets, and simultaneously performs a Vector Search on the text embedding 212 to find contextually similar information. These obtained results undergo a combine and re-rank process, which also considers the current content state information 310. The re-ranked information is converted into prompts, which are sequentially fed into the LLM or SLM to generate natural and contextually appropriate responses. The generated response is communicated to the user via dialog window 320, during which the consistency and appropriateness of the response is continuously monitored. In particular, the response generator 40 is designed to generate responses that are appropriate to the current situation while maintaining the persona of the AI companion 110, and includes the ability to adjust the emotion, tone, complexity, and other aspects of the response as needed.

The storage unit 60 is a central data management component that comprehensively manages all data in the system. All data is systematically stored and managed, including the basic data 121 and additional data 122 of the original AI companion 110, the knowledge graph 131 and text embedding 132, the knowledge graph 211 and text embedding 212 of the copied AI companion 210, the second user knowledge graph 220, and the content state information 310. The storage unit 60 has a structure that ensures independence while maintaining the relevance of each piece of data, enabling efficient complex data management. In addition, the structure adopts real-time updates and quick search capabilities to support the smooth operation of the AI companion 110. In particular, the system's stability is ensured through data versioning and backup functions, and data can be restored or rolled back as needed. This integrated data management system enables continuous development of the AI companion and the provision of stable services.

Referring now to FIGS. 1 through 3, a method for creating and sharing AI companion 110 will be described in more detail.

Referring to FIGS. 1 to 3, in order to effectively store and utilize the knowledge and memory of the AI companion 110, the system 1000 of the present invention provides data processing through two layers. The first layer is a layer that generates text embedding 132, and the second layer is a layer that generates knowledge graph 131. With this dual-layer structure, text embedding 132 is responsible for searching based on contextual similarity, and the knowledge graph 131 is responsible for storing information and representing relationships in a structured form. The persona data entered by the first user 100 is processed through these two layers, thereby allowing each AI companion 110 to have unique characteristics.

The first step in the process of generating text embedding 132 is the chunking of persona data. Persona data is data to describe the AI companion 110, which may be entered by the first user 100. The persona data may include basic data 121 and additional data 122, wherein basic data 121 is required input data and additional data 122 is optional additional input data at the option of the first user 100. The basic data 121 may be data in the form of prose describing various features of the AI companion 110, and may be in the form of natural language. Additional data 122 may refer to any data other than natural language data, and may include, for example, but is not limited to, dialog data, scenario data, novels, and the like.

Persona data, including basic data 121 and additional data 122, is chunked into specific text size units to account for the input limitations of the LLM model. Chunking can be adjusted on a per-dialog line basis or per-dialog chunk (paragraph) basis, to prevent some data from being ignored as the volume of prompts increases. In particular, the chunking process selects the optimal part without breaking the continuity of the context, which will directly affect the accuracy of the subsequent search.

Chunked data is embedded in vector space through the embedding model of the LLM server. Each chunk is given a specific coordinate value (address) in a high-dimensional vector space, where contextually similar texts are placed close to each other in the vector space. Specifically, input data can be preprocessed to be assigned an identifier and tokenized. Then, hyperparameters such as vector dimension, minimum word frequency, and number of training iterations are set, and the model is trained. The trained text embedding model can take chunked data as input and output a fixed-length vector. This vectorization process enables search based on semantic similarity rather than simple keyword matching. Embedding models are pre-trained to understand context and quantify it, allowing them to capture subtle nuances of text.

The knowledge graph 131 begins its generation by converting persona data into multiple triplets. Each triplet consists of three entities: a subject entity, a relationship entity (verb), and an object entity, which can be connected to each other like a chain. For example, multiple triplets included in the knowledge graph may include interconnected first and second triplets, where the object entity of the first triplet can be identical to the subject entity of the second triplet. The subject entity can be a person or object, the relationship entity typically takes the form of a verb, and the object entity can take the form of an adjective, object, or person. Particularly, the object of one triplet can become the subject of the next triplet, allowing for sequential expansion, which enables the representation of complex knowledge structures.

The basic structure of the knowledge graph 131 starts from the subject node N1 at the top and branches into the information node N2 and the relationship node N3. The information node N2 is where all types of information known to the AI companion 110 are organized, while the relationship node N3 is where information about the relationship between the AI companion 110 and the content's user is organized. These two nodes have a structure that is both independent and interconnected, with a hierarchical structure of levels 1, 2, and 3 formed below each node. This structure enables systematic organization and efficient retrieval of information.

Some of the nodes in the first level (LEVEL 1) below the information node N2 and the relationship node N3 are mandatorily generated by the system and form the basic knowledge structure of the AI companion 110. The remaining nodes are added dynamically as the triplets are created, and this dynamic scalability allows the AI companion 110 to continuously accumulate new information and experience. In particular, nodes at each level can have their own unique attributes while inheriting the characteristics of their parent nodes.

The knowledge graph generator 20 follows a specific algorithm when adding new triplets to the existing knowledge graph 131. First, it selects either a relationship node N3 or an information node N2, depending on the nature of the new information. It then explores information about existing nodes at the first level (LEVEL 1) under the selected node, and determines whether to create new triplets under existing first-level nodes or create a new first-level (LEVEL 1) node. The knowledge graph generator makes this decision based solely on information about the first-level (LEVEL 1) nodes directly under the selected relationship node N3 or information node N2, ensuring efficiency in the decision-making process.

When additional depth below the first level (LEVEL 1) is required, the knowledge graph generator 20 undergoes a more complex analysis process. After selecting one of the first-level (LEVEL 1) nodes, it analyzes all existing triplets under that node to determine the optimal position for the new triplet. Specifically, it uses information about all triplets from the second level (LEVEL 2) to the lowest level under the first-level (LEVEL 1) node to determine where to create the new triplet. This is a crucial process for maintaining and expanding the logical structure of knowledge. Particularly, as lower levels contain more specific and detailed information, careful consideration is needed to determine how new information should connect with the existing knowledge structure.

According to one embodiment, the connections between the triplets have a very flexible structure. Some of the nodes under the information node N2 may be connected by forming triplets with nodes under the relationship node N3, and vice versa. This cross-linking allows for the representation of complex knowledge and relationships, and enables the AI companion 110 to understand and utilize richer context. Furthermore, a single node can be included in multiple triplets simultaneously, allowing for the interpretation of information from multiple perspectives.

According to one embodiment, the directionality of triplets is also an important feature of the knowledge graph 131. By default, triplets have a directionality from higher levels to lower levels, but in special cases, reverse connections from lower levels to higher levels are possible. For example, such backward connections are used when it is necessary to express a relationship where a node at the second level (LEVEL 2) affects a node at the first level (LEVEL 1). This bidirectional connection structure allows for the effective representation of complex causal relationships or interactions, and is particularly useful when dealing with abstract concepts such as the emotional state or intent of the AI companion 110.

Text embedding 132 and knowledge graphs 131 have different purposes and characteristics. While text embedding 132 enables quick search based on contextual similarities, the knowledge graph 131 is utilized to extract and store deeper context, such as emotional states and intentions that are not directly apparent in the text. This dual structure allows the AI companion 110 to quickly retrieve contextually relevant information while generating responses based on a deeper understanding of context.

According to one embodiment, the knowledge graph 131 can also effectively manage changes in information over time. Each triplet is recorded with its creation timestamp, and when new information on the same topic is added, it is stored with its temporal relationship to existing information. This allows the AI companion 110 to determine the freshness of information and understand changes over time. In particular, in the structure under the relationship node N3, the history of interactions with the user is stored in chronological order so that the evolution of the relationship can be tracked.

According to one embodiment, various optimization techniques are applied during the text embedding process to increase search efficiency in the vector embedding space. For example, frequently co-occurring sentences are adjusted to be placed closer to each other in the vector space, and not only contextual but also functional similarities are considered. In addition, a contextual weighted search algorithm is applied during search, rather than a simple cosine similarity calculation. This results in more accurate and relevant search results.

Referring now to FIGS. 1, 3, and 4, the process by which the copied AI companion 210 is utilized in content (e.g., a game) by another user, i.e., how the AI companion 110 is shared and managed, will be described in more detail.

Specifically, the process of utilizing the copied AI companion 210 in content such as games consists of two main processes: response generation and state update. The copied AI companion 210 has its own knowledge graph 211 and text embedding 212, based on which it performs interactions with users communicating with the copied AI companion 210 through content created by the second user 200. The response generator 40 receives user input and generates appropriate responses, while the state analyzer 50 analyzes these interactions to continuously update the content's state and the knowledge structure of the copied AI companion 210. This real-time processing system enables the copied AI companion 210 to understand the content's context and generate natural responses accordingly.

The response generation process may receive input from users utilizing the content and generate responses using the knowledge graph 211 and text embedding 212. Specifically, the response generator 40 first performs a Graph Query on the knowledge graph 211 of the copied AI companion 210. In this process, starting from the subject node N1, it sequentially searches through multiple triplets via the information node N2 and relationship node N3 to collect all triplets related to the current situation. Information stored at each level is searched sequentially, with nodes related to the current content's context being prioritized. The collected triplets contain the copied AI companion 210's basic knowledge and interaction history to date, forming the basis for generating consistent responses.

Simultaneously, vector searches are performed on the text embedding 212. User input can be vectorized, and all vector data with addresses within a preset distance from the vectorized user input can be extracted as vector results and generated as search results for the text embedding 212. Methods for calculating distances in multidimensional vector space may include Euclidean Distance, Cosine Similarity, Manhattan Distance, and others, but are not limited to these. These vector searches are used to find data with the most similar contexts in the embedding space. The search is based on semantic similarity rather than simple keyword matching. The retrieved results include previous conversation records, response patterns in similar situations, and relevant background knowledge, all of which play important roles in creating natural conversation flow.

The results obtained from the graph search and vector search undergo a Combine and Re-rank process. That is, multiple triplets generated from the knowledge graph 211 search and multiple vector results generated from the text embedding 212 vector search can be combined and re-ranked.

According to one embodiment, the current content state information 310 can act as an important weighting factor in this process. Game state includes stage information, character information (User Stats, Companion Stats), and various variables, which directly affect the prioritization of search results. For example, information highly relevant to the current game stage or response patterns related to the current user state receive higher priority.

The re-ranked information is converted into prompts and sequentially input into the response generator 40. The response generator 40, consisting of an LLM or SLM, generates actual responses based on this information. The key is to generate responses appropriate to the current situation while maintaining consistency with the copied AI companion 210's persona. During response generation, the intensity of emotions, conversation tone, and response length are adjusted to fit the content's context, and may undergo multiple iterations of optimization as needed.

The state update process is performed in real-time by the state analyzer 50. Whenever user input or responses from the copied AI companion 210 occur, the state analyzer 50 analyzes them and updates various state information. Most fundamentally, it tracks conversation flow and context, leading to updates in the knowledge graph 211 and text embedding 212. Additionally, the relationship development between the user and copied AI companion 210, degree of emotional exchange, and interaction patterns are continuously analyzed and recorded.

The state analyzer 50 uses user input and copied AI companion 210's response data to generate prompts for state updates. These prompts are used to analyze and update the current content state 310, tracking changes in various game variables. Most importantly, it determines how these state changes should be reflected in the copied AI companion 210's knowledge structure. The state analyzer 50 updates the knowledge graph 211 and text embedding 212 by appropriately distributing the changed information, ensuring information consistency and continuity throughout the process.

The knowledge graph 211 is updated by adding new triplets or modifying existing ones. The state analyzer 50 converts new information into triplets as it comes in and adds them by selecting appropriate positions in either the information node N2 or relationship node N3. The optimal position is determined by considering relationships with existing nodes, and new node levels may be created if necessary. Particularly, changes in user relationships throughout game progression are recorded in detail within the relationship node N3 structure, forming a basis for future interactions. The process of updating the knowledge graph 211 and adding new triplets is identical to the method by which the knowledge graph generator 20 adds new triplets to knowledge graph 131 as described above, so duplicate explanation will be omitted.

Text embedding 212 updates occur simultaneously. New dialogue content or state changes are chunked into sentences and vectorized, then added to the existing text embedding 212 space. During this process, it's crucial to maintain consistency between new embeddings and the existing embedding structure. Additionally, to prevent the embedding space from becoming overly complex, less important information may be periodically compressed or removed.

The personality or behavioral patterns of the copied AI companion 210 may evolve as content progresses. These changes are implemented through structural modifications to the knowledge graph 211 or weight adjustments in the text embedding 212. For example, after experiencing specific events, the importance of related triplets may be increased, or new triplets reflecting new behavioral patterns may be added. These dynamic changes enable the copied AI companion 210 to naturally grow and evolve alongside content progression.

According to various features of the present invention, the AI companion creation and management system 1000 provides innovative systems and methods for creating, sharing, and managing AI companions 110. The AI companion 110 creation and sharing method generates text embedding 132 by chunking user's natural language data into sentences and builds a knowledge graph 131 comprising subject nodes N1, information node N2, and relationship node N3 based on these embeddings. Furthermore, the original AI companion 110 sharing and management method enables the copied AI companion 210 to function within content such as games. The response generator 40 combines and re-ranks knowledge graph 131 searches and text embedding 132 vector searches to generate contextual responses. The state analyzer 50 updates content state 310 and the copied AI companion 210's knowledge structure in real-time. These functions are implemented through an integrated system 1000 that includes the text embedding generator 10, knowledge graph generator 20, sharing unit 30, state analyzer 50, response generator 40, and storage unit 60, and communicates with the first user 100, second user 200, and other content users.

The present invention enables consistent persona maintenance, effective knowledge management, and natural interaction of the copied AI companion 210, particularly implementing more immersive AI companion services through personalized experiences via the second user knowledge graph 220, contextual understanding through real-time state analysis, and an efficient response generation system. This can provide innovative user experiences across various digital content fields such as games, virtual reality, and metaverses.

Of course, various embodiments of the present invention may be combined with each other to form new embodiments.

The AI companion generation and sharing method according to various embodiments of the present invention includes: (a) generating text embedding by chunking the first user's persona data into sentences, (b) generating multiple triplets using the persona data and generating a knowledge graph using these multiple triplets, and (c) generating the first user's AI companion using the text embedding and knowledge graph.

According to a feature of the present invention, step (a) further includes the step of assigning coordinate values in vector space so that contextually similar data are located adjacent to each other.

According to a feature of the present invention, a triplet included in the knowledge graph comprises a subject entity, an object entity, and a relationship entity that directionally connects the subject entity and object entity.

According to a feature of the present invention, the multiple triplets included in the knowledge graph comprise interconnected first and second triplets, where the object entity of the first triplet is identical to the subject entity of the second triplet.

According to a feature of the present invention, the knowledge graph includes a subject node at the top, and information node and relationship node that branch from and connect below the subject node, where the subject node, information node, and relationship node are essential.

According to a feature of the present invention, nodes under the information node of the knowledge graph can be connected as triplets with nodes under the relationship node.

According to a feature of the present invention, the knowledge graph may include triplets where the object entity's level is higher than the subject entity's level.

According to a feature of the present invention, step (b) further includes the step of adding new triplets to the knowledge graph, which comprises: (b-1) selecting either information node or relationship node of the knowledge graph, (b-2) obtaining information about existing nodes that include the first level below the node selected in step (b-1), and (b-3) determining whether to create new triplets under the existing nodes or create new triplets while creating new nodes at the first level below the node selected in step (b-1).

According to a feature of the present invention, if it is decided to create new triplets under existing nodes in step (b-3), the method further includes the step of determining where to create the new triplets using information about all triplets from the second level down to the lowest level under the existing nodes.

According to a feature of the present invention, the method further includes the step of sharing the first user's AI companion as a copied AI companion in the second user's content.

According to a feature of the present invention, the second user is restricted from accessing the first user's persona data.

The AI companion sharing and management method according to various embodiments of the present invention includes: (a) receiving input from a user utilizing the second user's content, (b) generating a response to the input using the knowledge graph and text embedding of the copied AI companion in the second user's content, and (c) updating the knowledge graph and text embedding based on the response.

According to another feature of the present invention, step (b) further includes the step of sequentially searching all triplets included in the knowledge graph based on the input to collect multiple triplets.

According to another feature of the present invention, step (b) further includes vectorizing the input and collecting multiple vector results having coordinate values spaced apart from the vectorized input by a preset distance or less in the text embedding's vector space.

According to another feature of the present invention, step (b) further includes: combining and re-ranking the multiple triplets collected from the knowledge graph and the multiple vector results collected from the text embedding; and sequentially inputting the re-ranked results to generate a response.

According to another feature of the present invention, step (c) further includes the step of adding new triplets to the knowledge graph, which comprises: (c-1) selecting either information node or relationship node of the knowledge graph, (c-2) obtaining information about existing nodes that include the first level below the node selected in step (c-1), and (c-3) determining whether to create new triplets under the existing nodes or create new triplets while creating new nodes at the first level below the node selected in step (c-1).

According to another feature of the present invention, if it is decided to create new triplets under existing nodes in step (c-3), the method further includes the step of determining where to create the new triplets using information about all triplets from the second level down to the lowest level under the existing nodes.

According to another feature of the present invention, step (c) further includes chunking the responses and assigning addresses in the text embedding's vector space to the chunked responses such that contextually similar data is located adjacent to each other.

According to another feature of the present invention, the method further includes updating the knowledge graph and text embedding based on the input after step (a) and before step (b).

According to another feature of the present invention, the method further comprises, before step (a), sharing the original AI companion of the first user as a copied AI companion on the second user's content.

According to another feature of the present invention, the knowledge graph comprises multiple triplets where three entities are directionally connected, and these multiple triplets are connected to each other forming a chain.

The AI companion generation and management system according to various embodiments of the present invention may include: a text embedding generator configured to generate text embedding by chunking the first user's persona data; a knowledge graph generator configured to generate triplets using the persona data and generate a knowledge graph using the triplets; and a sharing unit configured to generate a copied AI companion by copying the first user's original AI companion, generated using the text embedding and knowledge graph, onto the second user's content.

According to another feature of the present invention, the text embedding generator is configured to assign coordinate values in vector space to the chunked persona data such that contextually similar data is located adjacent to each other.

According to another feature of the present invention, a triplet included in the knowledge graph comprises a subject entity, an object entity, and a relationship entity that directionally connects the subject entity and object entity.

According to another feature of the present invention, the multiple triplets included in the knowledge graph comprise interconnected first and second triplets, where the object entity of the first triplet is identical to the subject entity of the second triplet.

According to another feature of the present invention, the system further comprises a response generator configured to generate responses to input using the copied AI companion's knowledge graph and text embedding in response to input received from users utilizing the second user's content.

According to another feature of the present invention, the response generator is further configured to collect multiple triplets by sequentially searching all triplets included in the knowledge graph based on the input.

According to another feature of the present invention, the response generator is further configured to vectorize the input and collect multiple vector results having coordinate values spaced apart from the vectorized input by a preset distance or less in the text embedding's vector space.

According to another feature of the present invention, the response generator is further configured to combine and re-rank multiple triplets collected from the knowledge graph and multiple vector results collected from text embedding, and to generate responses by sequentially inputting the re-ranked results.

According to another feature of the present invention, the system further comprises a state analyzer configured to update the copied AI companion's knowledge graph and text embedding when receiving input from users utilizing the second user's content and when generating responses to the input.

According to another feature of the present invention, the state analyzer is further configured to, when adding new triplets to the knowledge graph, select either information node or relationship node of the knowledge graph, obtain information about existing nodes that include the first level below the selected node, and determine whether to create new triplets under the existing nodes or create new triplets while creating new nodes at the first level below the selected node.

According to another feature of the present invention, in its determination, when the state analyzer decides to create new triplets under existing nodes, it is further configured to determine where to create the new triplets using information about all triplets from the second level down to the lowest level under the existing nodes.

According to another feature of the present invention, the state analyzer is further configured to chunk the responses and update text embedding by assigning addresses in the text embedding's vector space to the chunked responses such that contextually similar data is located adjacent to each other.

In and above, although the invention has been described with reference to specific details, such as specific components and limited embodiments and drawings provided for a more general understanding of the invention, the invention is not limited to these embodiments, and those with ordinary knowledge in the field to which the invention belongs may make various modifications and variations from these descriptions.

Therefore, the idea of the invention should not be limited to the embodiments described above, and it should be understood that all modifications that are equal or equivalent to the following claims, as well as the claims themselves, fall within the scope of the idea of the invention.

What is claimed is:

1. A method of generating and managing an AI companion, comprising:
(a) generating text embedding by chunking persona data of a first user;
(b) generating a plurality of triplets using the persona data and generating a knowledge graph using the plurality of triplets; and
(c) generating the AI companion of the first user using the text embedding and the knowledge graph.

2. The method of claim 1, wherein:
the step (a) comprises assigning addresses in a vector space to the chunked persona data such that contextually similar data is located adjacent to each other.

3. The method of claim 1, wherein:
triplet included in the knowledge graph comprise a subject entity, an object entity, and a relationship entity which directionally connects the subject entity and the object entity.

4. The method of claim 1, wherein:
the knowledge graph comprises: a subject node at the uppermost level, an information node and a relationship node which are branched from the subject node and connected to a lower level of the subject node, wherein the subject node, the information node and the relationship node are essential.

5. The method of claim 1, further comprising:
(d) sharing the AI companion of the first user as a copied AI companion on content of a second user.

6. The method of claim 1, further comprising:
(e) receiving an input from a user utilizing content of a second user;
(f) generating a response to the input using a knowledge graph and text embedding of a copied AI companion on content of the second user; and
(g) updating the knowledge graph and the text embedding of the copied AI companion based on the response.

7. The method of claim 6, wherein:
the step (f) comprises sequentially searching all triplets included in the knowledge graph of the copied AI companion to collect a plurality of triplets.

8. The method of claim 6, wherein:
the step (f) comprises:
vectorizing the input; and
collecting a plurality of vector results having coordinate values spaced apart from the vectorized input by a preset distance or less in a vector space of the text embedding of the copied AI companion.

9. The method of claim 6, wherein:
the step (f) comprises:
combining and re-ranking a plurality of triplets collected from the knowledge graph of the copied AI companion and a plurality of vector results collected from the text embedding; and
sequentially inputting the re-ranked results to generate the response.

10. The method of claim 1, wherein:
the step (b) comprises:
further comprising adding new triplets to the knowledge graph, wherein
the adding the new triplets comprises:
(b-1) selecting one of information node and relationship node of the knowledge graph;
(b-2) obtaining information about existing nodes included in a first level below the node selected in the step (b-1);
(b-3) determining whether to create the new triplets below the existing nodes or to create the new triplets while creating new nodes at the first level below the node selected in the step (b-1).

11. A system for generating and managing an AI companion, comprising:
a text embedding generator configured to generate text embedding by chunking persona data of a first user;
a knowledge graph generator configured to generate triplets using the persona data and generate a knowledge graph using the triplets; and
a sharing unit configured to generate a copied AI companion by copying an original AI companion of the first user created using the text embedding and the knowledge graph onto content of a second user.

12. The system of claim 11, wherein:
the text embedding generator is configured to assign addresses in a vector space to the chunked persona data such that contextually similar data is located adjacent to each other.

13. The system of claim 11, wherein:
triplets included in the knowledge graph comprise a subject entity, an object entity, and a relationship entity that directionally connects the subject entity and the object entity.

14. The system of claim 11, wherein:
the plurality of triplets comprised in the knowledge graph comprise mutually connected first triplet and second triplet, wherein an object entity of the first triplet is identical to a subject entity of the second triplet.

15. The system of claim 11, further comprising:
a response generator configured to generate a response to the input using the knowledge graph and the text embedding of the copied AI companion in response to input received from users utilizing content of the second user.

16. The system of claim 15, wherein:
the response generator is further configured to collect a plurality of triplets by sequentially searching all triplets included in the knowledge graph based on the input.

17. The system of claim 15, wherein:
the response generator is further configured to vectorize the input and collect a plurality of vector results having coordinate values spaced apart from a vectorized input by a preset distance or less in a vector space of the text embedding.

18. The system of claim 15, wherein:
the response generator is further configured to combine and re-rank a plurality of triplets collected from the knowledge graph and a plurality of vector results collected from the text embedding, and to generate the response by sequentially inputting the re-ranked results.

19. The system of claim 11, further comprising:
a state analyzer configured to update a knowledge graph and a text embedding of the copied AI companion when receiving input from users utilizing content of the second user and when generating a response to the input.

20. The system of claim 19, wherein:
the state analyzer is further configured to:
when adding new triplets to the knowledge graph of the copied AI companion,
select one of information node or relationship node in the knowledge graph of the copied AI companion;
obtain information about existing nodes included in a first level below the selected node; and
determine whether to create the new triplets below the existing nodes or create the new triplets after creating new nodes at the first level below the selected node.
